(19) United States
(12) Patent Application Publication
(10) Pub. No.: US 2025/0055074 A1
(43) Pub. Date: Feb. 13, 2025

(54) THERMAL BARRIER BLANKET SYSTEMS FOR USE WITHIN TRACTION BATTERY PACKS

(71) Applicant: FORD GLOBAL TECHNOLOGIES, LLC, Dearborn, MI (US)

(72) Inventors: Ravi Jagdish Saripella, Farmington Hills, MI (US); Steven F. Chorian, Canton, MI (US); Mark Elio Parenti, Clinton Township, MI (US); Timothy Andrew Strand, Plymouth, MI (US)

(21) Appl. No.: 18/446,693

(22) Filed: Aug. 9, 2023

(51) Int. Cl. H01M 10/658; H01M 50/244; H01M 50/30

(52) U.S. Cl. CPC H01M 10/658; H01M 50/244; H01M 50/30; H01M 2220/20

(57) ABSTRACT

Thermal barrier blanket systems are provided for use within traction battery packs. Exemplary thermal barrier blanket systems may include a plurality of thermal barrier panels that are arranged in an overlapping configuration. The thermal barrier panels may be arranged such that, during a battery thermal event, battery vent gases and/or other effluents are forced over top of downstream thermal barrier panels, thereby slowing array-to-array propagation times and preserving the structural integrity of surrounding enclosure structures.

### TECHNICAL FIELD

This disclosure relates generally to electrified vehicle traction battery packs, and more particularly to thermal barrier blanket systems for use within battery arrays of traction battery packs.

### BACKGROUND

A high voltage traction battery pack typically powers the electric machines and other electrical loads of an electrified vehicle. The traction battery pack includes a plurality of battery cells and various other battery internal components that support the electric propulsion of the vehicle.

### SUMMARY

A traction battery pack according to an exemplary aspect of the present disclosure includes, among other things, a thermal barrier blanket system including a first thermal barrier panel that at least partially overlaps a second thermal barrier panel.

In a further non-limiting embodiment of the foregoing traction battery pack, the first thermal barrier panel covers a first battery array, and the second thermal barrier panel covers a second battery array that is adjacent to the first battery array.

In a further non-limiting embodiment of either of the foregoing traction battery packs, the first thermal barrier panel includes a second lateral edge flange that overlaps a first lateral edge flange of the second thermal barrier panel.

In a further non-limiting embodiment of any of the foregoing traction battery packs, the first lateral edge flange includes a cupped portion that is configured to engage a stanchion.

In a further non-limiting embodiment of any of the foregoing traction battery packs, the stanchion is attached to a crossmember beam located between a first battery array that is beneath the first thermal barrier panel and a second battery array that is beneath the second thermal barrier panel.

In a further non-limiting embodiment of any of the foregoing traction battery packs, the first thermal barrier panel is secured to the stanchion by a fastener.

In a further non-limiting embodiment of any of the foregoing traction battery packs, the first lateral edge flange includes a slanted surface that establishes portions of a gas path that extends over top of the second thermal barrier panel.

In a further non-limiting embodiment of any of the foregoing traction battery packs, the gas path additionally extends between a top cover of a first battery array and the first thermal barrier panel.

In a further non-limiting embodiment of any of the foregoing traction battery packs, the first thermal barrier panel and the second thermal barrier panel each include a flame resistant and heat insulation material.

In a further non-limiting embodiment of any of the foregoing traction battery packs, the flame resistant and heat insulation material includes mica, aerogel materials, and/or refractory ceramic fibers.

A traction battery pack according to another exemplary aspect of the present disclosure includes, among other things, a first battery array covered by a first thermal barrier panel of a thermal barrier blanket system, and a second battery array covered by a second thermal barrier panel of the thermal barrier blanket system. Each of the first thermal barrier panel and the second thermal barrier panel includes a first lateral edge flange and a second lateral edge flange. The second lateral edge flange of the first thermal barrier panel at least partially overlaps the first lateral edge flange of the second thermal barrier panel.

In a further non-limiting embodiment of the foregoing traction battery pack, a crossmember beam is located between the first battery array and the second battery array.

In a further non-limiting embodiment of either of the foregoing traction battery packs, a stanchion is attached to the crossmember beam.

In a further non-limiting embodiment of any of the foregoing traction battery packs, the first lateral edge flange of the second thermal barrier panel includes a cupped portion that is configured to engage the stanchion.

In a further non-limiting embodiment of any of the foregoing traction battery packs, the first thermal barrier panel is secured to the stanchion by a fastener.

In a further non-limiting embodiment of any of the foregoing traction battery packs, the first lateral edge flange of the second thermal barrier panel includes a slanted surface that establishes portions of a gas path that extends over top of the second thermal barrier panel.

In a further non-limiting embodiment of any of the foregoing traction battery packs, the gas path additionally extends between a top cover of the first battery array and the first thermal barrier panel.

In a further non-limiting embodiment of any of the foregoing traction battery packs, the gas path additionally extends between the second lateral edge flange of the first thermal barrier panel and the first lateral edge flange of the second thermal barrier panel.

In a further non-limiting embodiment of any of the foregoing traction battery packs, the first thermal barrier panel and the second thermal barrier panel each include a flame resistant and heat insulation material.

In a further non-limiting embodiment of any of the foregoing traction battery packs, the flame resistant and heat insulation material includes mica, aerogel materials, and/or refractory ceramic fibers.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 is a cross-sectional view of the traction battery pack of FIG. 2.

FIG. 4 is a top view of a thermal barrier blanket system for use within a traction battery pack.

FIG. 5 is a side view of the thermal barrier blanket system of FIG. 4.

FIG. 6 is angled blown-up view of portions of the thermal barrier blanket system of FIG. 5.

FIG. 7 schematically illustrates a gas path established between adjacent battery arrays by a thermal barrier blanket system.

### DETAILED DESCRIPTION

This disclosure details exemplary thermal barrier blanket systems for use within traction battery packs. Exemplary thermal barrier blanket systems may include a plurality of thermal barrier panels that are arranged in an overlapping configuration. The thermal barrier panels may be arranged such that, during a battery thermal event, battery vent gases and/or other effluents are forced over top of downstream thermal barrier panels, thereby slowing array-to-array propagation times and preserving the structural integrity of surrounding enclosure structures. These and other features are discussed in greater detail in the following paragraphs of this detailed description.

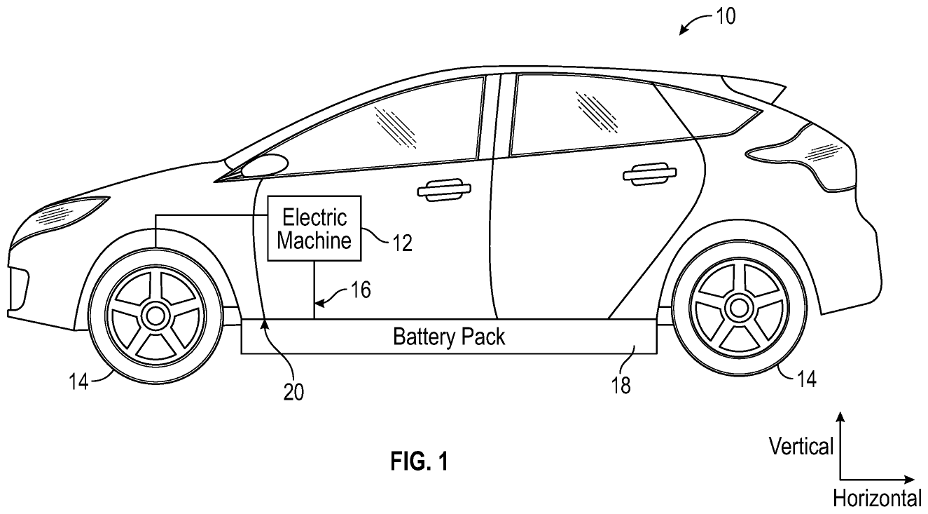

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

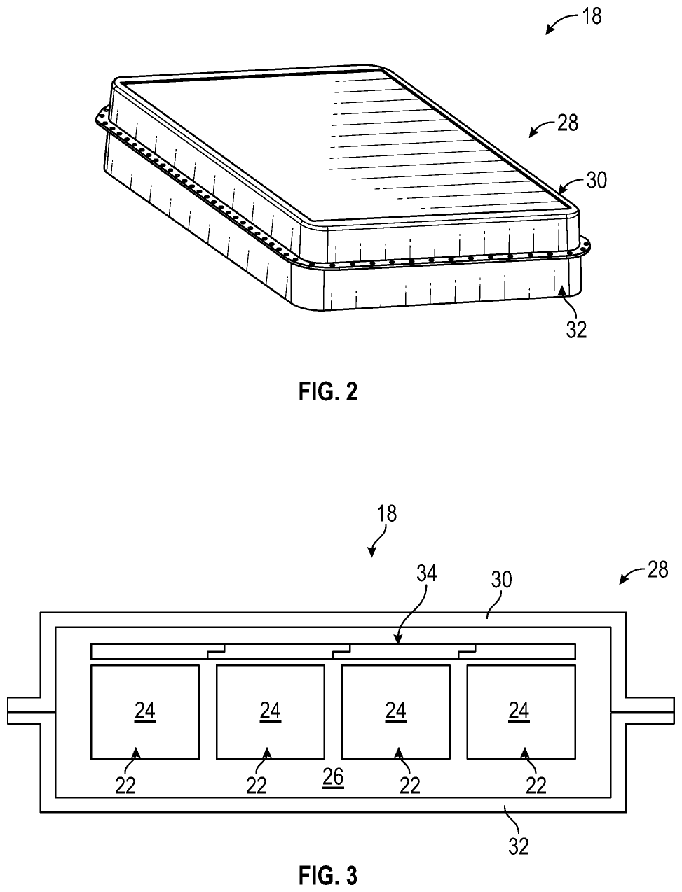

FIGS. 2 and 3 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked side-by-side along a stack axis to construct a grouping of battery cells 24, sometimes referred to as a “cell stack.” In the highly schematic depiction of FIG. 3, the battery cells 24 are stacked in a direction into the page to construct each battery array 22, and thus the battery arrays 22 may extend in cross-car direction. However, other configurations may also be possible. The total number of battery arrays 22 and battery cells 24 provided within the traction battery pack 18 is not intended to limit this disclosure.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

From time to time, pressure and thermal energy inside one or more of the battery cells 24 can increase during a battery thermal event, such as that resulting from an overcharge condition, an overdischarging condition, or a short circuit event, for example. The pressure and thermal energy increase can cause the associated battery cell 24 to generated a relatively significant amount of heat, and in some rare instances, may cause battery vent gases and/or other effluents to be released from within an interior of the associated battery cell 24.

The traction battery pack 18 may include a thermal barrier blanket system 34 configured for managing/mitigating the effects of battery thermal events. Among other benefits, the thermal barrier blanket system 34 may be configured to manage array-to-array propagation of battery cell vent gases and/or effluents and may further limit the vent gases and/or effluents and associated heat from influencing the structural integrity of the enclosure cover 30 and/or the enclosure tray 32.

The thermal barrier blanket system 34 may be positioned within the interior area 26 of the enclosure assembly 28. In an embodiment, the thermal barrier blanket system 34 is arranged in the space between the battery arrays 22 and the enclosure cover 30. However, other configurations are contemplated within the scope of this disclosure.

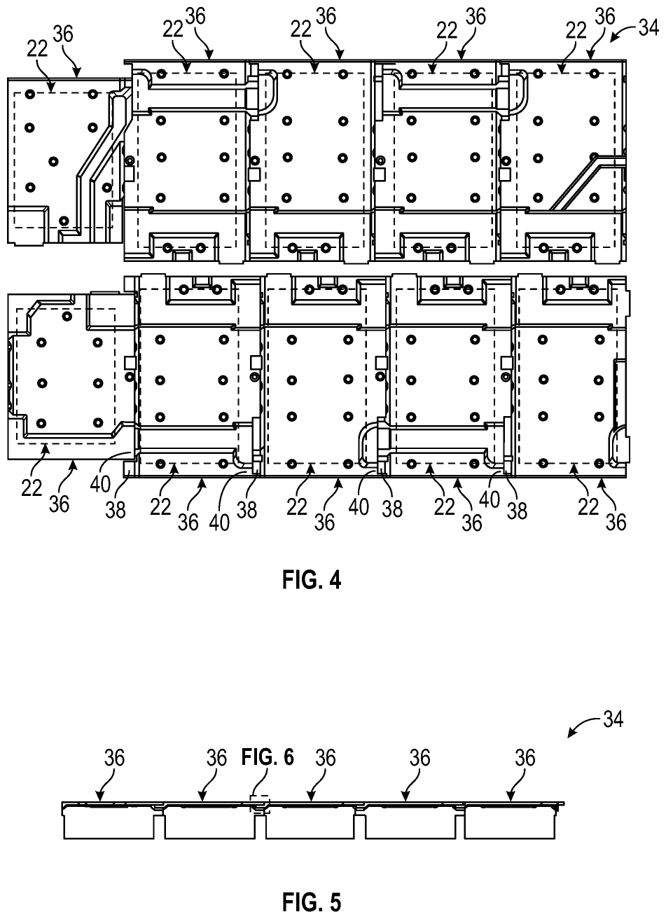

FIGS. 4, 5, and 6 illustrate additional details associated with the thermal barrier blanket system 34 of the traction battery pack 18. The thermal barrier blanket system 34 may include a plurality of thermal barrier panels 36. In this illustrated embodiment, the thermal barrier blanket system 34 includes a total of ten thermal barrier panels 36. However, a greater or fewer number of thermal barrier panels 36 could be provided within the scope of this disclosure. In general, the number of thermal barrier panels 36 provided as part of the thermal barrier blanket system 34 will match the number battery arrays 22 provided within the traction battery pack 18.

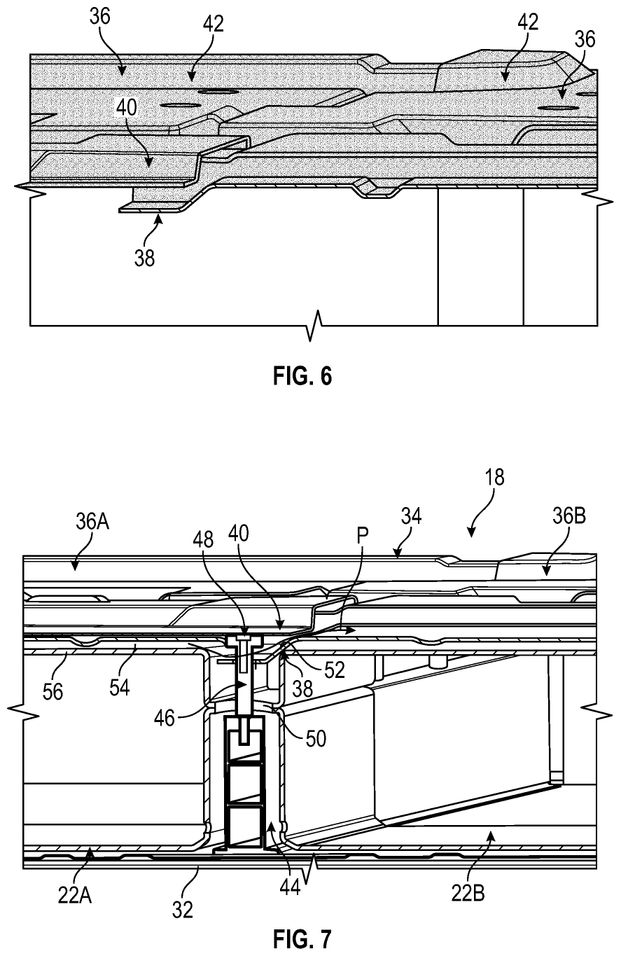

Each thermal barrier panel 36 may provide a blanket-like design that is arranged to cover one of the battery arrays 22 of the traction battery pack 18. The battery arrays 22 are schematically illustrated in FIG. 4 but are omitted in FIGS. 5 and 6 for simplicity.

One or more of the thermal barrier panels 36 may be configured differently from the other thermal barrier panels 36 of the thermal barrier blanket system 34. The thermal barrier panels 36 can be configured differently in terms of size, shape, features, etc.

Each thermal barrier panel 36 may be arranged to overlap with at least one neighboring thermal barrier panel 36 to establish a “shingled” or “shiplapped” configuration of the thermal barrier blanket system 34. For example, each thermal barrier panel 36 may include a first lateral edge flange 38 and a second lateral edge flange 40. The first lateral edge flange 38 and the second lateral edge flange 40 may extend in parallel with a longitudinal axis of each battery array 22, for example. As best shown in FIG. 6, the second lateral edge flange 40 of at least some of the thermal barrier panels 36 may be arranged to overlap portions of the first lateral edge flange 38 of a neighboring thermal barrier panel 36.

Each thermal barrier panel 36 may include a flame resistant and heat insulation material 42 (shown schematically in FIG. 6). The flame resistant and heat insulation material 42 may include mica, aerogel materials, refractory ceramic fibers, etc. However, other materials or combinations of materials could with utilized to provide the flame resistant and heat insulation properties within each thermal barrier panel 36 within the scope of this disclosure.

Referring now to FIG. 7, a crossmember beam 44 may be arranged between an adjacent set of battery arrays 22A, 22B of the traction battery pack 18. The battery arrays 22A, 22B may be secured relative to the enclosure tray 32 via the crossmember beam 44.

A stanchion 46 may be mounted to the crossmember beam 44. A fastener 48 may be inserted through a thermal barrier panel 36A of the thermal barrier blanket system 34 and into the stanchion 46 in order to mount the thermal barrier panel 36A to the stanchion 46.

The thermal barrier panel 36A may be mounted such that the second lateral edge flange 40 of the thermal barrier panel 36A overlaps the first lateral edge flange 38 of another thermal barrier panel 36B of the thermal barrier blanket system 34. The first lateral edge flange 38 of the thermal barrier panel 36B may include a cupped surface 50 that interfaces with the stanchion 46. For example, the cupped surface 50 may be received about a portion of the stanchion 46 for securing the thermal barrier panel 36B in place.

The first lateral edge flange 38 of the thermal barrier panel 36B may further include a slanted surface 52. The slanted surface 52 may act as blocking structure, as further discussed below.

For example, when a battery thermal event occurs in the battery array 22A, the thermal barrier panel 36A may diffuse the velocity of the vent and/or other effluents released from the source battery cell(s) 24, thereby protecting the enclosure cover 30. The diffused battery vent gases and/or other effluents may then travel downstream from the battery array 22A along a gas path P. The gas path P may extend within a passageway 54 located between the thermal barrier panel 36A and a top cover 56 of the battery array 22A and then over top of the thermal barrier panel 36B via the slanted surface 52, which functions as a blocking structure for preventing gases and/or effluents from traveling between the thermal barrier panel 36B and the battery array 22B. Instead, the gases and/or other effluents are forced to flow above the thermal barrier panel 36B, thereby slowing array-to-array propagation times and protecting the battery array 22B from high temperatures associated with the vent gases and/or effluents.

The exemplary thermal barrier blanket systems of this disclosure are designed to manage the effects of battery thermal events within a traction battery pack. The systems may provide numerous advantages over known solutions, including but not limited to presenting a novel configuration that significantly slows array-to-array propagation times while also preserving the structural integrity of the battery outer enclosure structures.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a thermal barrier blanket system including a first thermal barrier panel that at least partially overlaps a second thermal barrier panel.

2. The traction battery pack as recited in claim 1, wherein the first thermal barrier panel covers a first battery array, and the second thermal barrier panel covers a second battery array that is adjacent to the first battery array.

3. The traction battery pack as recited in claim 1, wherein the first thermal barrier panel includes a second lateral edge flange that overlaps a first lateral edge flange of the second thermal barrier panel.

4. The traction battery pack as recited in claim 3, wherein the first lateral edge flange includes a cupped portion that is configured to engage a stanchion.

5. The traction battery pack as recited in claim 4, wherein the stanchion is attached to a crossmember beam located between a first battery array that is beneath the first thermal barrier panel and a second battery array that is beneath the second thermal barrier panel.

6. The traction battery pack as recited in claim 5, wherein the first thermal barrier panel is secured to the stanchion by a fastener.

7. The traction battery pack as recited in claim 3, wherein the first lateral edge flange includes a slanted surface that establishes portions of a gas path that extends over top of the second thermal barrier panel.

8. The traction battery pack as recited in claim 7, wherein the gas path additionally extends between a top cover of a first battery array and the first thermal barrier panel.

9. The traction battery pack as recited in claim 1, wherein the first thermal barrier panel and the second thermal barrier panel each include a flame resistant and heat insulation material.

10. The traction battery pack as recited in claim 9, wherein the flame resistant and heat insulation material includes mica, aerogel materials, and/or refractory ceramic fibers.

11. A traction battery pack, comprising:
a first battery array covered by a first thermal barrier panel of a thermal barrier blanket system; and
a second battery array covered by a second thermal barrier panel of the thermal barrier blanket system,
wherein each of the first thermal barrier panel and the second thermal barrier panel includes a first lateral edge flange and a second lateral edge flange, and
wherein the second lateral edge flange of the first thermal barrier panel at least partially overlaps the first lateral edge flange of the second thermal barrier panel.

12. The traction battery pack as recited in claim 11, comprising a crossmember beam located between the first battery array and the second battery array.

13. The traction battery pack as recited in claim 12, comprising a stanchion attached to the crossmember beam.

14. The traction battery pack as recited in claim 13, wherein the first lateral edge flange of the second thermal barrier panel includes a cupped portion that is configured to engage the stanchion.

15. The traction battery pack as recited in claim 13, wherein the first thermal barrier panel is secured to the stanchion by a fastener.

16. The traction battery pack as recited in claim 11, wherein the first lateral edge flange of the second thermal barrier panel includes a slanted surface that establishes portions of a gas path that extends over top of the second thermal barrier panel.

17. The traction battery pack as recited in claim 16, wherein the gas path additionally extends between a top cover of the first battery array and the first thermal barrier panel.

18. The traction battery pack as recited in claim 17, wherein the gas path additionally extends between the second lateral edge flange of the first thermal barrier panel and the first lateral edge flange of the second thermal barrier panel.

19. The traction battery pack as recited in claim 11, wherein the first thermal barrier panel and the second thermal barrier panel each include a flame resistant and heat insulation material.

20. The traction battery pack as recited in claim 19, wherein the flame resistant and heat insulation material includes mica, aerogel materials, and/or refractory ceramic fibers.
